(19) United States
(12) Patent Application Publication
(10) Pub. No.: US 2009/0276436 A1
(43) Pub. Date: Nov. 5, 2009

(54) Method, apparatus, and computer program product for providing service invitations

(75) Inventors: Jari Otranen, Espoo (FI); Marko Anderson, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/112,001

(22) Filed: Apr. 30, 2008

(51) Int. Cl. G06F 17/30

(52) U.S. Cl. 707/10; 707/E17.032

(57) ABSTRACT

An apparatus for providing service invitations may include a processor. The processor may be configured to receive user contacts associated with a user. The user contacts may be received from a server, a mobile terminal, or the like. The user contacts may also be received in response to an invitation associated with the user. The processor may also be configured to compare user contacts with a service member database to determine a member status associated with each user contact. The processor may be further configured to provide for invitations via the user contacts based on the associated member statuses. Associated methods and computer program products may also be provided.

### TECHNICAL FIELD

Embodiments of the present invention relate generally to communicating information and, more particularly, relate to an apparatus, method and a computer program product for providing service invitations.

### BACKGROUND

The information age has brought about a tremendous expansion in the amount of information and other content available to users via networking technologies such as the Internet. It seems that as more content is made available, the demand for additional, new content continues to increase. Many users of the Internet perform searches daily, and even hourly, to locate products, services, information, or other content that the users may desire. Due to this demand for content, every day new and unique websites, widgets, web feeds, applications, online services, and other content are made available to users of the Internet to view, download, execute, or the like. However, with the increasing influx of accessible content on the Internet, users may find it difficult to share and coordinate the utilization of common content amongst their friends, family, and business contacts.

For example, consider a new application that is made available on the Internet that may be useful or otherwise intriguing to a user. The user may discover the application via, for example, a search engine, and download and execute, or otherwise interact with the application. If the user indeed finds the application to be useful or intriguing, the user may wish to share the application with friends, family, and business contacts.

Similarly, the business that made the application available to the user may also wish to have the user share the application with the user's friends, family, and business contacts. In this manner, the business may gain additional exposure for the application and attract more users. The increased utilization of the application by additional users may result in increased profits for the business from, for example, advertising associated with the application.

As such, it would be desirable to provide mechanisms for sharing information about new content, including online services, which a user may find useful or otherwise intriguing. Moreover, it would be desirable to provide mechanisms that allow users to readily share the content with friends, relatives, and business contacts that the user may often interact with via networking technologies.

### BRIEF SUMMARY

A method, apparatus, and computer program product are therefore described that provide for service invitations. In this regard, exemplary embodiments of the present invention may receive user contacts associated with a user. The user contacts may be received from a server, a mobile terminal, or the like. The user contacts may also be received in response to an invitation associated with the user. Various exemplary embodiments may also compare user contacts with a service member database to determine a member status associated with each user contact. The comparison may identify member and non-member user contacts. Exemplary embodiments may also provide for invitations via the user contacts based on the associated member statuses.

Exemplary embodiments may also compare the member user contacts with a relationship group associated with the user to identify related and unrelated user contacts. In this regard, exemplary embodiments may also add the unrelated user contacts to the relationship group to thereby change the unrelated user contacts to related user contacts, and provide for invitations via the related user contacts.

In one exemplary embodiment, a method for providing service invitations is described. The method may include receiving user contacts associated with a user in response to an invitation associated with the user and comparing the user contacts with a service member database to determine a member status associated with each user contact. The method may further include providing for invitations via the user contacts based on the associated member statuses.

In another exemplary embodiment, a computer program product for providing service invitations is described. The computer program product may include at least one computer-readable storage medium having computer-readable program code portions stored therein. The computer-readable program code portions may include a first program code portion, a second program code portion, and a third program code portion. The first program code portion may be configured to receive user contacts associated with a user in response to an invitation associated with the user. The second program code portion may be configured to compare the user contacts with a service member database to determine a member status associated with each user contact, and the third program code portion may be configured to provide for invitations via the user contacts based on the associated member statuses.

In another exemplary embodiment, an apparatus for providing service invitations is described. The apparatus may include a processor. The processor may be configured to receive user contacts associated with a user in response to an invitation associated with the user and compare the user contacts with a service member database to determine a member status associated with each user contact. The processor may be further configured to provide for invitations via the user contacts based on the associated member statuses.

In one exemplary embodiment, an apparatus for providing service invitations is described. The apparatus may include means for receiving user contacts associated with a user in response to an invitation associated with the user and means for comparing the user contacts with a service member database to determine a member status associated with each user contact. The apparatus may further include means for providing for invitations via the user contacts based on the associated member statuses.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 illustrates a block diagram showing an apparatus for providing service invitations with associated network connectivity according to an exemplary embodiment of the present invention;

FIG. 3 illustrates an exemplary contact tree according to exemplary embodiments of the present invention;

FIGS. 4 and 5 are flowcharts according to exemplary methods for providing service invitations according to exemplary embodiments of the present invention;

FIG. 6 is a signaling diagram illustrating an exemplary communication process according to exemplary embodiments of the present invention; and

FIG. 7 illustrates an exemplary system of network entities according to exemplary embodiments of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

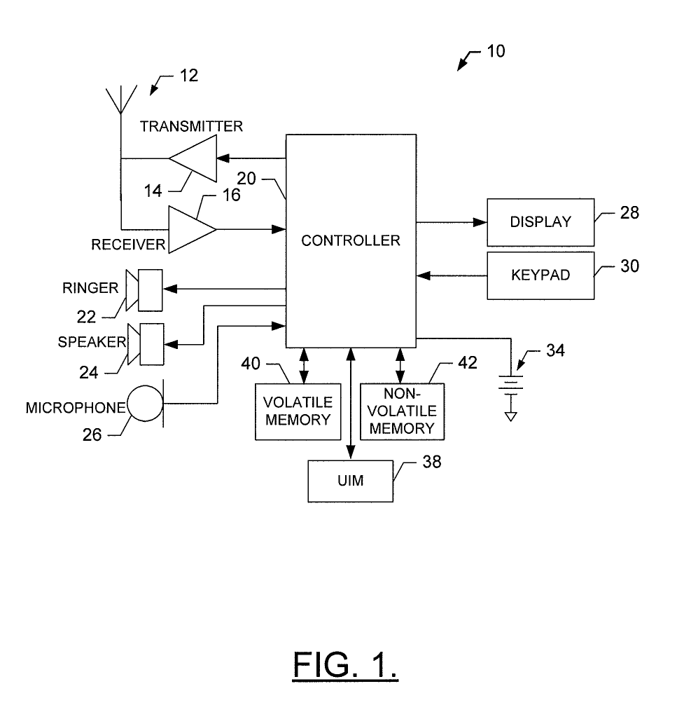

FIG. 1, one aspect of the invention, illustrates a block diagram of a mobile terminal 10 that would benefit from, and may be an exemplary apparatus of, embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, audio/video player, radio, GPS devices, or any combination of the aforementioned, and other types of voice and text communications systems, can readily employ embodiments of the present invention.

In addition, while several embodiments of the method of the present invention are performed or used by a mobile terminal 10, the method may be employed by other than a mobile terminal. Moreover, the apparatus and method of embodiments of the present invention will be primarily described in conjunction with mobile communications applications. It should be understood, however, that the apparatus and method of embodiments of the present invention can be utilized in conjunction with a variety of other applications, both in the mobile communications industries and outside of the mobile communications industries.

The mobile terminal 10 may include an antenna 12 (or multiple antennas) in operable communication with a transmitter 14 and a receiver 16. The mobile terminal 10 may further include an apparatus, such as a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9 generation (3.9G) wireless communication protocols, such as Evolved Universal Terrestrial Radio Access Network (E-UTRAN), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN), or other communication networks. Further, the mobile terminal 10 can communicate in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like.

It is understood that the apparatus, such as the controller 20, may include circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication.

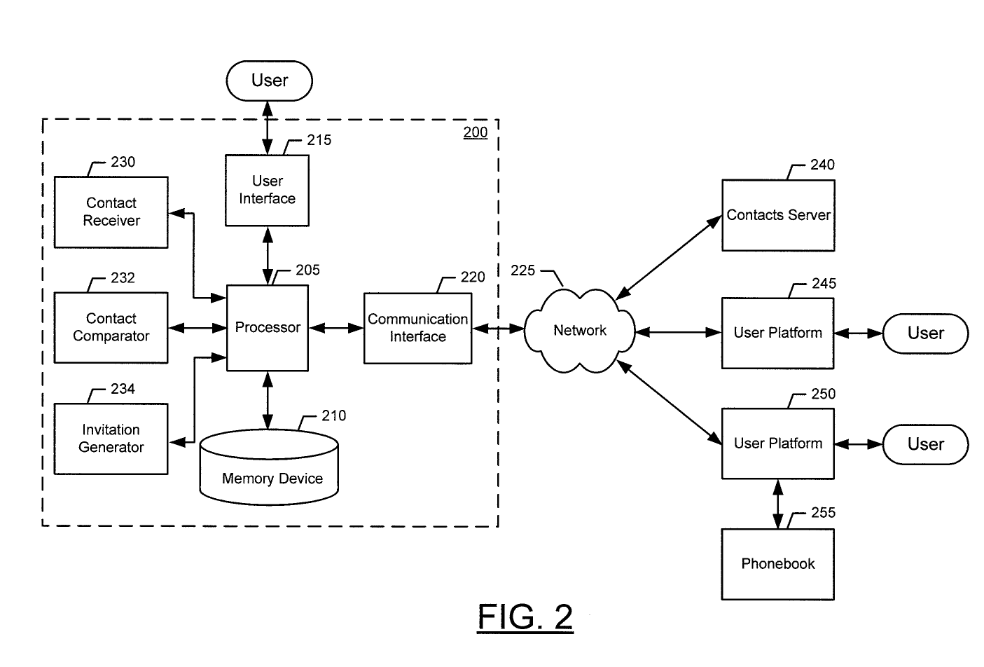

Referring now to FIG. 2, an exemplary apparatus 200 for providing service invitations is described. Apparatus 200 may be embodied as a server or other network device including, for example, a mobile terminal, such as mobile terminal 10 of FIG. 1. The apparatus 200 may include or otherwise be in communication with a processor 205, a user interface 215, a communication interface 220, and a memory device 210. The memory device 210 may include, for example, volatile and/or non-volatile memory (e.g., volatile memory 40 and/or non-volatile memory 42). The memory device 210 may be configured to store information, data, applications, instructions, or the like for enabling the apparatus to carry out various functions in accordance with exemplary embodiments of the present invention. For example, the memory device 210 could be configured to buffer input data for processing by the processor 205. Additionally or alternatively, the memory device 210 could be configured to store instructions for execution by the processor 205. As yet another alternative, the memory device 210 may be one of a plurality of databases that store information in the form of static and/or dynamic information, for example, in association with user contacts, invitations, member statuses, relationship groups, or the like.

The processor 205 may be embodied in a number of different ways. For example, the processor 205 may be embodied as a microprocessor, a coprocessor, a controller (e.g., controller 20 from FIG. 1), or various other processing means or elements including integrated circuits such as, for example, an ASIC (application specific integrated circuit) or FPGA (field programmable gate array). In an exemplary embodiment, the processor 205 may be configured to execute instructions stored in the memory device 210 or otherwise accessible to the processor 205.

The user interface 215 may be in communication with the processor 205 to receive an indication of a user input at the user interface 215 and/or to provide an audible, visual, mechanical, or other output to the user. As such, the user interface 215 may include, for example, a keyboard, a mouse, a joystick, a touch screen display, a conventional display, a microphone, a speaker, or other input/output mechanisms. In an exemplary embodiment in which the apparatus 200 is embodied as a server, the user interface 215 may be limited, or even eliminated.

The communication interface 220 may be embodied as any device or means embodied in either hardware, software, or a combination of hardware and software that is configured to receive and/or transmit data from/to a network and/or any other device or module in communication with the apparatus 200. In this regard, the communication interface 220 may include, for example, an antenna, a transmitter, a receiver, a transceiver and/or supporting hardware or software for enabling communications with network 225, which may be any type of wired or wireless network. Via the communication interface 220 and the network 225, the apparatus 200 may communicate with the contacts server 240, the user platform 245, and/or the user platform 250.

The contacts server 240 may be any type of computing device for storing, retrieving, computing, transmitting, and receiving data. The contacts server 240 may include a memory device, a processor, and a communication interface for communicating with the network 225. In some embodiments, the contacts server 240 may be a web server, database server, file server, or the like. According to various embodiments, the contacts server 240 may be a storage location for user contacts. In this regard, a user may upload user contacts to the contacts server 240 via, for example, network 225. For example, user contacts associated with the user platform 245 and/or the user platform 250 may be uploaded to the contact server 240 via network 225. Further, user contacts may be received from the contacts server 240 by various network entities including apparatus 200.

The user platforms 245, 250 may also be any type of device for storing, retrieving, computing, transmitting and receiving data. In some embodiments, user platforms 245, 250 may be embodied as a mobile terminal 10 of FIG. 1 or the like. User platforms may be associated with one or more user contacts such that a user contact may be used to direct communications (e.g., emails, SMS (short message service) messages, phone calls, etc.) to the user platforms and a user of the user platform. In some embodiments, user contacts may direct communications to a central holding location (e.g., a server) that may be accessed by a user via user platforms 245, 250. For example, email may be directed by a user contact to a server for holding until a user can access the server via a user platform and retrieve the email. User platforms 245, 250 are merely representative of a plurality of user platforms, and as such any number of user platforms may be included in FIG. 2. In some embodiments, via the user platforms 245, 250, a user may access an exemplary online service using a browser, a dedicated application, or the like.

User platform 250, as well as any other user platform, may also be associated with a phonebook 255. The phonebook 255 may include data including user contacts and associated information. The phonebook 255 may be stored on a memory device that is included with the user platform 255 or external to the user platform 250, similar to contact server 240. As described below, the data within the phonebook 255 may be synchronized with, for example, contacts server 240.

The contact receiver 230, the contact comparator 232, and the invitation generator 234 of apparatus 200 may be any means or device embodied in hardware, software, or a combination of hardware and software that is configured to carry out the functions of the contact receiver 230, the contact comparator 232, and the invitation generator 234, respectively, as described herein. In an exemplary embodiment, the processor 205 may include, or otherwise control the contact receiver 230, the contact comparator 232, and/or the invitation generator 234. In various exemplary embodiments, the contact receiver 230, the contact comparator 232, and the invitation generator 234 may reside on a server, or other network device including a mobile terminal, such as mobile terminal 10 of FIG. 1.

In some embodiments, the system of FIG. 2 may be utilized for synchronization of data amongst the various network platforms. In this regard, the network platforms (i.e., the apparatus 200, the contacts server 240, the user platforms 245, 250, etc.) may be used by a user to access data. In some embodiments, the network platforms may be used to access data associated with an online service account. Any type of data may be synchronized amongst the platforms and made available for access. Types of data may include status information, content, user profile information, shared files (e.g., documents, photos, media content, etc.), user contacts, invitations, service membership information, relationship group information, or the like. For example, a contacts list may be accessed and/or synchronized (i.e., updated) via the user platforms 245, 250, the contact server 240, or the apparatus 200. Upon modifying the contacts list, the new information may be transmitted to a data storage device (e.g., the apparatus 200 or the contact server 240) or otherwise made available to the various network platforms for subsequent access.

In this manner, data modified on one platform may be available to another platform. For example, the modified contact information may be automatically transmitted from the user platform 245 to the contact server 240 or the apparatus 200 for synchronization purposes. As such, the user may later access the modified contact information via user platform 250 and/or a browser.

In some embodiments, a user may set synchronization parameters, which may identify types of data that should be synchronized and types of data that need not be synchronized. For example, a user may set the synchronization parameters to synchronize the contact list, but may also set the synchronization parameters such that user profile information need not be synchronized. In various embodiments, various user contacts, invitations, service membership information, and/or relationship group information may or may not be synchronized.

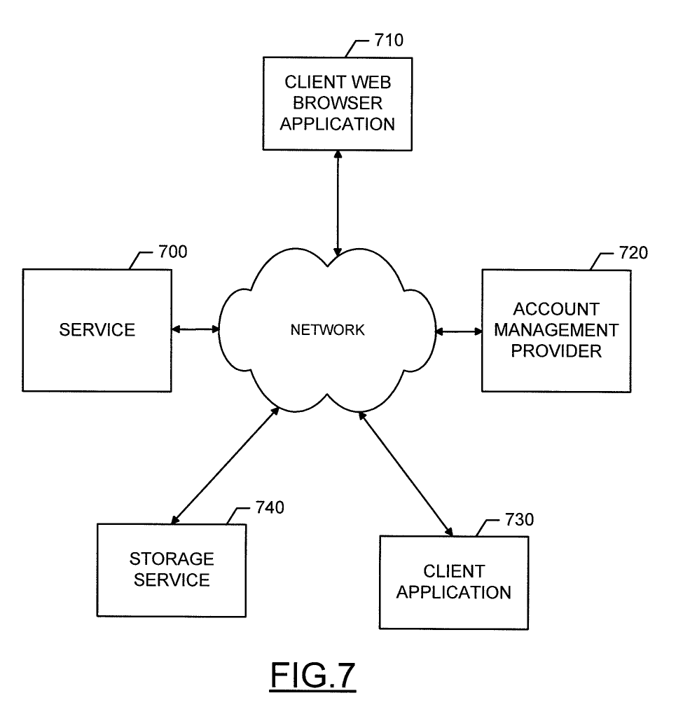

In this regard, and referring now to FIG. 7, an embodiment of a system in accordance with aspects of the present invention is illustrated. The system of FIG. 7 includes a service 700, a client web browser application 710, an account management provider 720, a client application 730, and a storage service 740. The service 700, the client web browser application 710, the account management provider 720, the client application 730, and the storage service 740 may be interconnected via the illustrated network, which may operate in the same manner as network 225.

The service 710, the account management provider 720, and the storage service 740 may collectively represent an embodiment of the apparatus 200 of FIG. 2. In this regard, the service 710 may represent an internet or network service (e.g., a website, a social networking website, a blog website, a web feed, a widget, or the like) that may receive and interact with user contacts and/or the like in a manner described with respect to the contact receiver 230, the contact comparator 232, the invitation generator 234, and the processor 205. Various types of data, such as, but not limited to, user contacts, may be synchronized with and/or otherwise transferred to and from the service 700. The service 700 may utilize the storage service 740 for storage and retrieval of data by the service 700. In various embodiments, the storage service 740 may operate in the same manner as the memory device 210 and/or the server 240. Further, the account management provider 720 may operate together with the various other network entities to perform account management and security features. In some embodiments, login information and passwords are first directed to the account management provider 720 for verification. Upon verification, the account management provider 720 may provide access to, and allow communications between, various network entities using, for example, a token or other access key.

Client application 730 may be a software or hardware application residing and operating on a platform, such as a computer, mobile terminal, or the like, that may be used to interact with the service 700. In some embodiments, the client application 730 may reside and operate on the apparatus 200, the user platforms 245, 250, or the like, and may operate in the same manner as apparatus 200, the user platforms 245, 250, or the like. The client application may be downloaded to and/or installed on the platform. In some embodiments, the client application 730 may be specifically tailored to interact with the service 700. Via the client application 730, the platform, and the user of the platform, may interact with the service 700 to send and receive data, such as user contacts, between the client application 730 and the service 700. The client application 730 may facilitate the gathering and storage of usage attributes for subsequent transmission to the service 700.

Similar to the client application 730, the client web browser application 710 may be a software or hardware application residing and operating on a platform, such as a computer, mobile terminal, or the like, that may be used to interact with the service 700. In this regard, the client web browser application 710 may be a generic network communication application for interacting with various network entities, including the service 700. In some embodiments, the client web browser application 710 may reside and operate on the apparatus 200, the user platforms 245, 250, the computer 250, or the like, and may operate in the same manner as the apparatus 200, the user platforms 245, 250, or the like. Via the client web browser application 710, the platform, and the user of the platform, may interact with the service 700 to send and receive, as well as synchronize, data, such as usage attributes, between the client web browser application 710 and the service 700. The client web browser application 710 may facilitate the gathering and storage of usage attributes for subsequent transmission to the service 700.

Referring back to FIG. 2, the contact receiver 230 may be configured to receive user contacts associated with a user. Means for receiving the user contacts may include the processor 205, the contact receiver 230, a receiver, algorithms for receiving the user contacts described herein and/or the like. The contact receiver 230 or the processor 205 may be configured to store the plurality of user contacts on the memory device 210. A user contact may include information for directing communications to a user contact entity (e.g., an individual or other entity). In this regard, information for directing communications to a user contact entity may include a phone number, a mailing address, an email address, a user identifier, a social networking account identifier, or the like. A user may be associated with a list or other grouping of user contacts. The user contacts associated with a user may be representative of the user's friends, family members, business associates, or the like.

Further, user contacts may be received in response to an invitation associated with a user. In this regard, an invitation may be any type of communication that may be conveyed to a user, such as, for example, an invitation for the user to join a virtual social network or the like. In some embodiments, user contact may be received in response to generation of an invitation associated with a user. The invitation may be generated by apparatus 200, or other entity such as, for example, a user platform of another user that desires to invite the user to join an exemplary virtual social network. Further, in some embodiments, user contacts may be received at regular or irregular intervals, continuously, and/or whenever the user contacts are modified.

For example, a first user (e.g., the user associated with the user platform 245) may have discovered a new online service (e.g., website, widget, online application, social networking website, or the like), and after registering for the online service, the first user may wish to invite a second user (e.g., the user associated with user platform 250) to join the online service. In this regard, the first user may provide for the generation of an invitation on apparatus 200 to the second user. As such, in response to the generation of this invitation, user contacts associated with the second user may be received by the contact receiver 230.

Further, in some embodiments, user contacts may be received in response to an invitation that has been generated, sent, and received. In this regard, a first user associated with a first user platform (e.g., the user platform 245) may invite a second user associated with a second user platform (e.g., the user platform 250) to join an online service. The second user and the second user platform may receive the invitation and register for the online service. In some embodiments, the registration may be received by apparatus 200. Apparatus 200 may, in response to the invitation and the registration, provide for transmission of a request for the user contacts associated with the second user and receive the second user's user contacts. Further, in some instances, the second user may already be registered for the online service upon receipt of the invitation. In these instances, the online service may be automatically activated, if the service was not previous activated, by the second user platform. Further, even though the second user may be already registered for the service, user contacts associated with the second user may still be received by the contact receiver 230 and apparatus 200.

The user contacts may be received from the contact server 240, the user platforms 245, 250, and/or the memory device 210. In this regard, in some embodiments, in response to generation of an invitation, a request for user contacts may be provided for by the contact receiver 230 and transmitted to the contact server 240, the user platforms 245, 250, and/or the memory device 210. The contact server 240, the user platforms 245, 250, and/or the memory device 210 may respond by transmitting the user contacts back to the processor 205. In some embodiments, user platform 245 or 250 may be embodied as a mobile terminal, such as mobile terminal 10, and the user contacts may be received, directly or indirectly, from the mobile terminal.

In embodiments where the user contacts are received from the contacts server 240 or memory device 210, the contacts server 240 and/or the memory device 210 may have previously received the user contacts from a user platform, such as user platforms 245, 250. In this regard, a user may define the user contacts on the user platform and then upload the user contacts to the contacts server 240 and/or the memory device 210. For example, a user may define user contacts on a user platform that is embodied as a mobile terminal, such as mobile terminal 10, and upload the contacts from the mobile terminal to the contacts server 240 or memory device 210.

The contact comparator 232 may be configured to compare user contacts with a service member database to determine a member status associated with each user contact. Means for comparing user contacts with a service member database may include the processor 205, the contact comparator 232, algorithms for comparing user contacts with a service member database described herein and/or the like. In this regard, memory device 210 of apparatus 200, or another network entity of the network 225 may include a service member database. The service member database may hold records indicating the individuals or entities that are currently registered or otherwise affiliated with an online service. As such, the user contacts that are received in association with an invited user, or in some instances a now registered user, may be compared to the service member database to identify whether each of the user contacts is a member user contact (i.e., a match was found) or a non-member user contact (i.e., no match was found). The status of being a member user contact or a non-member user contact may be referred to as the member status of the user contact.

The invitation generator 234 may be configured to provide for invitations via user contacts, to the user contact entities, based on member statuses associated with the user contacts. Means for providing for invitations may include the processor 205, the invitation generator 234, algorithms for providing for invitations described herein and/or the like. In this regard, the invitation generator 234 may provide for communications (e.g., emails, SMS messages, instant messages, phone calls, or the like) to the user contact entities described by the user contacts.

With respect to the member statuses, invitations may be provided for by the invitation generator 234 that are directed to non-member user contact entities inviting the non-member user contact entities to join an exemplary online service. In turn, the user contacts of the non-member user contact entities may be received by the contact receiver 230 and compared to the service member database by the contact comparator 232. In this regard, the member statuses of the user contacts associated with the non-member user contact entities may be included in an invitation to non-member user contact entities indicating, for example, the number and/or names of user contacts associated with each of the non-member user contact entities that are member user contacts. For example, an invitation may state “You have 3 contacts that are already members of this online service, would you like to join?” In other words, invitations may include information regarding who else is a member of the online service and thus, encouraging the non-member to join.

Further with respect to member user contacts, the invitation generator 234 may also provide for invitations to member user contact entities. In this regard, the invitation may be a notification that a new user has registered for an online service or the like. As a result, the user contacts of the member user contacts may be received by the contact receiver 232 and compared to the service member database to determine non-member user contacts of the member user contact entities. In this regard, the invitation to the member user contact entity may include an inquiry asking if the user would like to initiate an invitation to the non-member user contact entities associated with the member user contact entities.

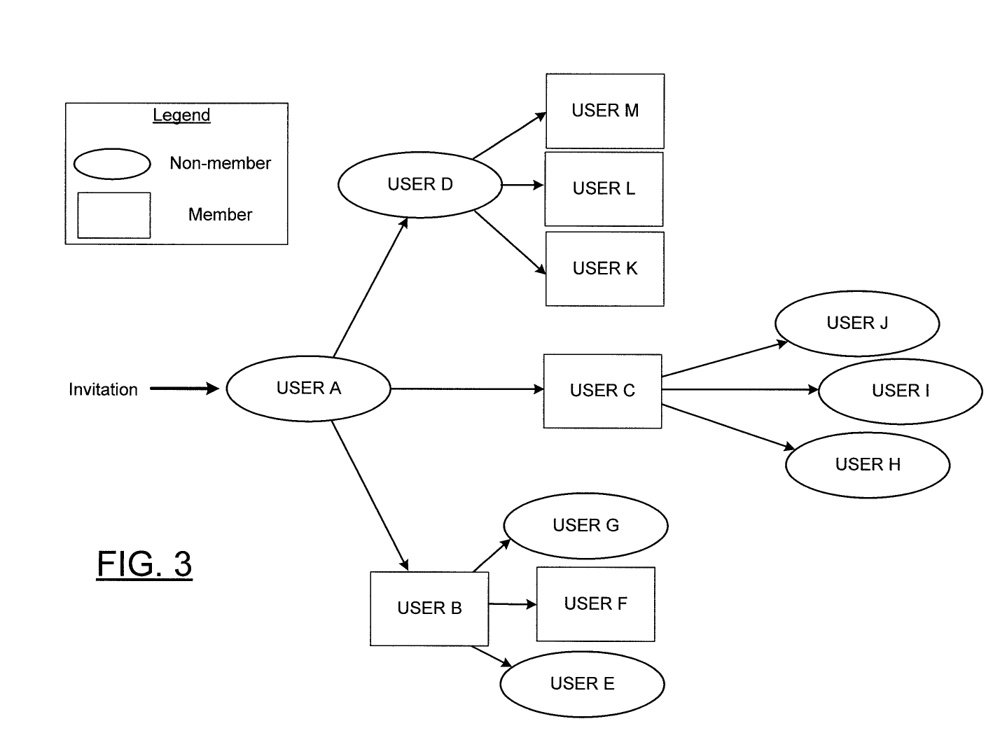

FIG. 3 illustrates a tree structure of user contacts that may be used to describe the distribution of invitations according to various embodiments of the present invention. In this regard, an invitation may be generated or transmitted to non-member User A. User A may have three user contacts (i.e., User B, User C, and User D) in an exemplary user contact list that was uploaded to a contacts server. In response to the invitation to User A, the user contacts of User A may be received and compared to the service member database. The comparison determines that User B and User C are members, but User D is a non-member. As such User A's invitation may indicate that User B and User C are already members, encouraging User A to join. Further, User A may initiate invitations to User B, User C, and User D. With respect to User B, User B's user contacts may be received and compared. Since User B is already a member, the invitation to User B may indicate that User A is now a member, and include an inquiry asking whether User B desires to send invitations to non-members, User G and User E. Similarly, with respect to User C, User C's user contacts may be received and compared, and since User C is also already a member, the invitation to User C may indicate that User A is now a member, and include an inquiry asking whether User C desires to send invitations to non-members (i.e., User J, User I, and User E). With respect to User D, since User D is a non-member, User D's user contacts may be received and compared and User D may receive an invitation indicating that User A is now a member and indicating that User K, User L, and User M are already members, thus encouraging User D to join. As such, distribution of invitations may continue with the user contacts of User E though User M (associated user entities not depicted).

In another embodiment of the present invention, the contact comparator 232 may be configured to compare member user contacts with a relationship group associated with a user to identify unrelated member user contacts. Means for identifying unrelated member user contacts may include the processor 205, the contact comparator 232, algorithms for identifying unrelated member user contacts described herein and/or the like. The relationship group may be retrieved from the memory device 210 or an online service server. In this regard, a relationship group may include a list of member user contacts that are further associated with the user within the online service. For example, in a social networking online service, member user contacts may be identified that have registered for the online service. However, according to various embodiments, a user of an online service may generate a relationship group (e.g., friends list, buddy list, etc.) within the online service. The contact comparator 232 may compare the identified as member user contacts to the relationship group of a user to identify related member user contacts and unrelated member user contacts.

In some embodiments, upon identifying the unrelated member user contacts, apparatus 200 and processor 205 may be configured to provide for transmission of an inquiry, which may be embodied as another invitation, to the user and the associated user platform that has received an earlier invitation. In this regard, the inquiry may indicate that unrelated member user contacts have been identified and ask whether the user would like to add the unrelated member user contacts to the user's relationship group. By adding the unrelated member user contacts to the user relationship group, the unrelated member user contacts may become related member user contacts. In some embodiments, no inquiry need be sent to the user and the unrelated member user contacts may be added to the user's relationship group automatically. In any event, the invitation generator 234 may be configured to add the unrelated member user contacts to the relationship group of a user to thereby change the unrelated user contacts to related user contacts. Means for adding the unrelated member user contacts may include the processor 205, the contact comparator 232, algorithms for adding the unrelated member user contacts described herein and/or the like.

For example, when a user registers for an online service or logs onto an online service for the first time, the user contacts associated with the user either on the contacts server 240 or in the phonebook 255 can be retrieved by apparatus 200 and contact receiver 230. The contact comparator 232 may then determine a member status and relationship status for each of the retrieved user contacts. If it is determined that some of the retrieved user contacts are unrelated members, then the invitation generator 234 may include information such as, for example, “20 of your contacts are using this service, do you want to add them as friends?” in an invitation. If the user chooses to add the user contacts as friends then the user contact can be added to the user's relationship group and the identified unrelated member user contacts may become related member user contacts. An automatic invitation may also be sent to the new related member user contact entities requesting to have the entities add the user to the entities' relationship group. In some embodiments, this automatic invitation may be limited to only members of the same service and invitations to user contacts that are not member of the service may be sent manually by the user through the online service.

Further, in some embodiments, the invitation generator 234 may generate invitations based on membership of a user contact to another service. For example, consider a user contact associated with user 1, where the user contact is identified as a member of service 1 but is not a member of service 2. Apparatus 200 and contact receiver 230 may receive user contacts, and the contact comparator 232 may determine the member status with respect to a plurality of services. If user contacts are identified that are members of a first service, but not members of a second service, invitations can be generated by the invitation generator 234, encouraging the associated user contacts entities to join the services that they are not currently a member of.

Further, the invitation generator 234 may be configured to provide for invitations via the related and unrelated member user contacts. In this regard, the invitation generator 234 may provide for invitations to related member user contacts indicating that the user has recently added the member user contact to the user's relationship group. Further, the invitation generator 234 may provide for invitations to unrelated member user contacts indicating that that the user is now a member, and inquiring whether the unrelated member user contact entity would like to add the user to the unrelated member user contact entity's relationship group.

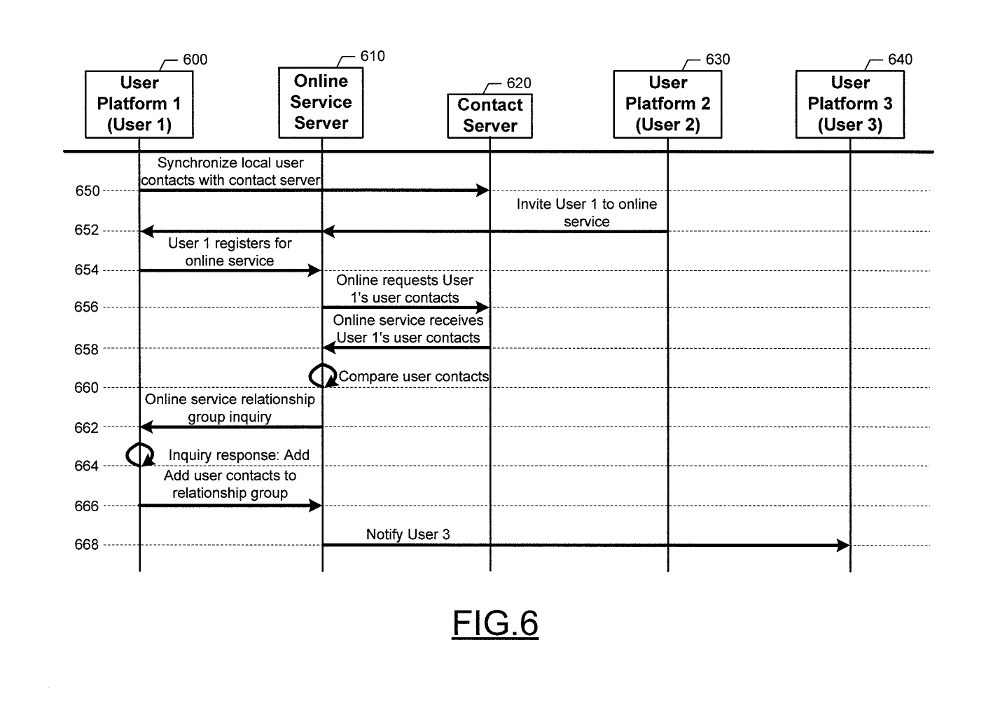

FIG. 6 is a signaling diagram illustrating an exemplary communication process according to exemplary embodiments of the present invention. The communications of FIG. 6 occur between a user platform 1 associated with a user 1 at 600, an online service server 610, a contact server 620, a user platform 2 associated with user 2 at 630, and a user platform 3 associated with user 3 at 640. The user platforms 1, 2, and 3 may be any type of user platforms such as, for example, the user platforms 245, 250 of FIG. 2. The online service server 610 may be any type of server associated with the operation of an online service, and the online service server 610 may be embodied as the apparatus 200 of FIG. 2. The contact server may be any type of server, such as, for example, the contact server of FIG. 2.

In the scenario associated with FIG. 6, user 1 has defined user contacts that include user 2 and user 3 on the user platform 1. User 2 and user 3 are currently members of the online service associated with the online service server 610.

At 650, the user platform 1 may synchronize a local phonebook with the contact server 620. As such, the contact server may include information indicating that user 2 and user 3 are user contacts of user 1. At 652, user 2 may generate an invitation, via user platform 2, to user platform 1 and user 1, inviting user 1 to join the online service. At 654, user 1 may register or otherwise sign-up for the online service by transmitting a registration communication to the online service server 610. At 656, the online service server may request user 1's user contacts from the contact server 620. At 658, the online service server may receive user 1's user contacts from the contact server 620. The online service server 610 may then compare the received user contacts to a local or external service member database at 660 to determine a member status of the user contacts. Since user 2 and user 3 are both members, user 2 and user 3 will be identified as member user contacts.

Upon identifying the member statuses of the user contacts, an inquiry can be sent to the user platform 1 at 662 asking whether user 1 would like to add user 3 to user 1's relationship group within the online service. User 1 may respond by requesting that user 3 be added to user 1's relationship group at 664. At 666, the request to add user 3 to user 1's relationship group may be transmitted to and implemented on the online service server 610. In response, a notification or invitation can be forwarded from the online service server 610 to the user platform 3 notifying user 3 that user 1 has become a member of the service and has added user 3 to user 1's relationship group. At this point, in some embodiments, the communication flow can repeat with respect to user 3's user contacts.

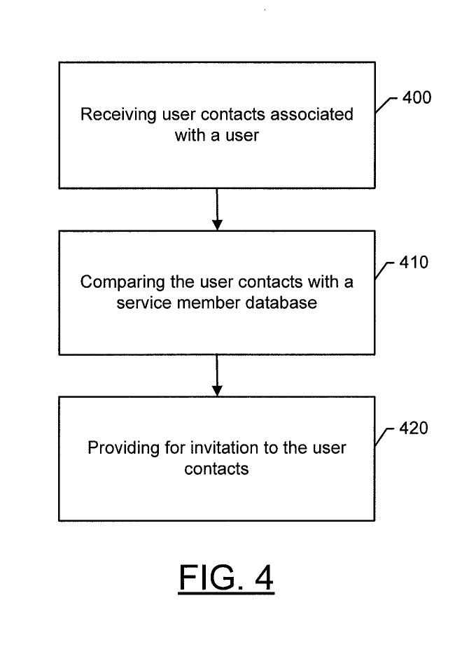

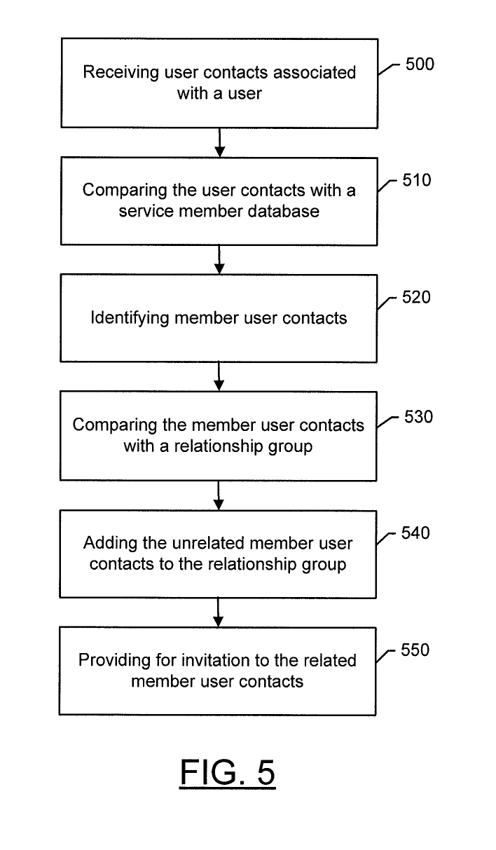

FIGS. 4 and 5 are flowcharts of a system, method, and program product according to exemplary embodiments of the invention. It will be understood that each block, step, or operation of the flowcharts, and combinations of blocks, steps or operations in the flowcharts, can be implemented by various means, such as hardware, firmware, and/or software including one or more computer program code portions, program instructions, or executable program code portions. For example, one or more of the procedures described above may be embodied by computer program code instructions. In this regard, the computer program instructions which embody the procedures described above may be stored by a memory device of the apparatus and executed by a processor in the apparatus. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s), step(s), or operation(s). These computer program instructions may also be stored in a computer-readable memory that can direct a computer, a processor, or other programmable apparatus to function in a particular manner, such that the instructions stored in the computer-readable memory produce an article of manufacture including instruction means which implement the function specified in the flowcharts block(s), step(s), or operation(s). The computer program instructions may also be loaded onto a computer, processor, or other programmable apparatus to cause a series of operational steps to be performed on the computer, processor, or other programmable apparatus to produce a computer-implemented process such that the instructions which execute on the computer, processor, or other programmable apparatus provide steps for implementing the functions specified in the flowcharts block(s), step(s), or operation(s).

Accordingly, blocks, steps, or operations of the flowcharts support combinations of means for performing the specified functions, combinations of steps for performing the specified functions and program instruction means for performing the specified functions. It will also be understood that one or more blocks, steps, or operations of the flowcharts, and combinations of blocks, steps, or operations in the flowcharts, can be implemented by special purpose hardware-based computer systems which perform the specified functions or steps, or combinations of special purpose hardware and computer instructions.

In this regard, one exemplary embodiment of a method for service invitations as illustrated in FIG. 4 may include receiving user contacts associated with a user at 400. The user contacts may be received in response to an invitation associated with the user. Further, the user contacts may be received from a contact server. In this regard, the contact server may have received the user contacts from one or more user platforms, one of which may have been a mobile terminal. In some embodiments of the method, user contacts may be received directly from a user platform, such as a mobile terminal.

The exemplary method of FIG. 4 may further include comparing the user contacts with a service member database to determine a member status associated with each user contact at 410. In some embodiments, comparing the user contacts with the service member database may further include identifying member or non-member user contacts from the user contacts based on the associated member statuses.

The exemplary method of FIG. 4 may also include providing for invitations via the user contacts based on the associated member statuses at 420. In some embodiments, the method may include providing for invitations via member and/or non-member user contacts.

Another exemplary embodiment of a method for providing service invitations as illustrated in FIG. 5 may include receiving user contacts associated with a user at 500. The user contacts may be received in response to an invitation associated with the user. Further, the user contacts may be received from a contact server. In this regard, the contact server may have received the user contacts from one or more user platforms, one of which may have been a mobile terminal. In some embodiments of the method, user contacts may be received directly from a user platform, such as a mobile terminal.

The exemplary method of FIG. 5 may further include comparing the user contacts with a service member database to determine a member status associated with each user contact at 510. In some embodiments, comparing the user contacts with the service member database may further include identifying member or non-member user contacts from the user contacts based on the associated member statuses.

The exemplary method may also include identifying member user contacts at 520. In this regard, the member user contacts may be identified from the user contacts based on the associated member statuses. The exemplary method may further include comparing the member user contacts with a relationship group at 530. In this regard, the relationship group may be associated with the user, and the relationship group may be compared to the member user contacts to identify related and unrelated member user contacts.

At 540, the exemplary method may include adding the unrelated member user contacts to the relationship group. By adding the unrelated member user contacts to the relationship group, the unrelated member user contacts may be changed to related member user contacts. Further, at 550, the exemplary method may also include providing for invitations via the related and/or unrelated member user contacts. In some embodiments, the providing for invitations may include providing for invitations via the user contacts based on the associated member statuses.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving user contacts associated with a user in response to an invitation associated with the user;
comparing the user contacts with a service member database to determine a member status associated with each user contact; and
providing for invitations via the user contacts based on the associated member statuses.

2. The method of claim 1, wherein receiving user contacts includes receiving user contacts from a contact server, the contact server having received the user contacts from a mobile terminal.

3. The method of claim 1, wherein receiving user contacts includes receiving user contacts from a mobile terminal associated with the user.

4. The method of claim 1 wherein comparing the user contacts includes identifying member user contacts from the user contacts based on the associated member statuses; and wherein providing for invitations includes providing for invitations via the member user contacts indicating member status information of the additional contacts associated with each member user contact.

5. The method of claim 1 further comprises:
identifying member user contacts from the user contacts based on the associated member statuses;
comparing the member user contacts with a relationship group associated with the user to identify unrelated user contacts;
adding the unrelated user contacts to the relationship group, thereby changing the unrelated user contacts to related user contacts; and
wherein providing for invitations includes providing for invitations via the related user contacts.

6. The method of claim 1, wherein comparing the user contacts with the service member database further comprises identifying non-member user contacts from the user contracts based on the associated member statuses; and wherein providing for invitations includes providing for invitations via the non-member contacts.

7. A computer program product comprising at least one computer-readable storage medium having computer-readable program code portions stored therein, the computer-readable program code portions comprising:
a first program code portion configured to receive user contacts associated with a user in response to an invitation associated with the user;
a second program code portion configured to compare the user contacts with a service member database to determine a member status associated with each user contact; and
a third program code portion configured to provide for invitations via the user contacts based on the associated member statuses.

8. The computer program product of claim 7, wherein the first program code portion being configured to receive user contacts includes being configured to receive user contacts from a contact server, the contact server having received the user contacts from a mobile terminal.

9. The computer program product of claim 7, wherein the first program code portion being configured to receive user contacts includes being configured to receive user contacts from a mobile terminal associated with the user.

10. The computer program product of claim 7, wherein the second program code portion configured to compare the user contacts include being configured to identify member user contacts from the user contacts based on the associated member statuses; and
wherein the third program code portion being configured to provide for invitations includes being configured to provide for invitations via the member user contacts indicating member status information of the additional contacts associated with each member user contact.

11. The computer program product of claim 7, wherein the computer-readable program code portions further comprise:
a fourth program code portion configured to identify member user contacts from the user contacts based on the associated member statuses;
a fifth program code portion configured to compare the member user contacts with a relationship group associated with the user to identify unrelated user contacts;
a sixth program code portion configured to add the unrelated user contacts to the relationship group, thereby changing the unrelated user contacts to related user contacts; and
wherein the third program code portion being configured to provide for invitations includes being configured to providing for invitations via the related user contacts.

12. The computer program product of claim 7, wherein the second program code portion being configured to compare the user contacts with the service member database includes being further configured to identify non-member user contacts from the user contracts based on the associated member statuses; and wherein the second program code portion being configured to provide for invitations includes being configured to provide for invitations via the non-member contacts.

13. An apparatus comprising a processor, the processor configured to:
receive user contacts associated with a user in response to an invitation associated with the user;
compare the user contacts with a service member database to determine a member status associated with each user contact; and
provide for invitations via the user contacts based on the associated member statuses.

14. The apparatus of claim 13, wherein the processor being configured to receive user contacts includes being configured to receive user contacts from a contact server, the contact server having received the user contacts from a mobile terminal.

15. The apparatus of claim 13, wherein the processor being configured to receive user contacts includes being configured to receive user contacts from a mobile terminal associated with the user.

16. The apparatus of claim 13, wherein the processor being configured to compare the user contacts include being configured to identify member user contacts from the user contacts based on the associated member statuses; and wherein the processor being configured to provide for invitations includes being configured to provide for invitations via the member user contacts indicating member status information of the additional contacts associated with each member user contact.

17. The apparatus of claim 13, wherein the processor is further configured to:
identify member user contacts from the user contacts based on the associated member statuses;
compare the member user contacts with a relationship group associated with the user to identify unrelated user contacts;
add the unrelated user contacts to the relationship group, thereby changing the unrelated user contacts to related user contacts; and
wherein the processor being configured to provide for invitations includes being configured to provide for invitations via the related user contacts.

18. The apparatus of claim 13, wherein the processor being configured to compare the user contacts with the service member database includes being further configured to identify non-member user contacts from the user contracts based on the associated member statuses; and wherein the processor being configured to provide for invitations includes being configured to provide for invitations via the non-member contacts.

19. The apparatus of claim 13 further comprising a memory device, and wherein the processor is further configured to store the user contacts in the memory device.

20. An apparatus comprising:
means for receiving user contacts associated with a user in response to an invitation associated with the user;
means for comparing the user contacts with a service member database to determine a member status associated with each user contact; and
means for providing for invitations via the user contacts based on the associated member statuses.

21. The apparatus of claim 20 further comprising:
means for identifying member user contacts from the user contacts based on the associated member statuses;
means for receiving additional contacts associated with each member user contact;
means for comparing the additional contacts with a service member database to determine a member status for each additional contact; and
wherein the means for providing for invitations includes means for providing for invitations via the member user contacts indicating member status information of the additional contacts associated with each member user contact.
